(19) United States
(12) Patent Application Publication
(10) Pub. No.: US 2017/0213187 A1
(43) Pub. Date: Jul. 27, 2017

(54) STORAGE APPARATUS AND CONTROL METHOD THEREOF

(71) Applicant: Samsung Electronics Co., Ltd, Gyeonggi-do (KR)

(72) Inventors: Eun Ha Choi, Gyeonggi-do (KR); Jae Hyung Kim, Gyeonggi-do (KR); Jin Wook Kim, Gyeongsangbuk-do (KR)

(21) Appl. No.: 15/411,915

(22) Filed: Jan. 20, 2017

(30) Foreign Application Priority Data
Jan. 21, 2016 (KR) 10-2016-0007609

(51) Int. Cl. G06Q 10/08; H04N 7/18; H04N 5/247; G06K 7/14; G06K 7/10

(52) U.S. Cl. CPC G06Q 10/0833; G06K 7/1413; G06K 7/1417; G06K 7/10297; H04N 5/247; H04N 7/188; H04N 7/181

(57) ABSTRACT

A storage apparatus and a method for controlling the same are disclosed, which relate to a technology for a storage apparatus and a method for controlling the same to receive or return a package, which should be stored at a controlled temperature, such as food, in a non-face to face manner using two doors open in opposite directions such that a delivery person and a consumer do not meet each other.

The storage apparatus includes a first door, a second door provided to face the first door, an imaging device configured to acquire an image of the package accommodated in the storage apparatus, a communicator configured to transmit the acquired image of the package to an external device, and a controller configured to control a storage temperature for the package in accordance with a package storage temperature set by the external device based on the image of the package.

### CROSS-REFERENCE TO RELATED APPLICATION(S) AND CLAIM OF PRIORITY

The present application is related to and claims the benefit of Korean Patent Application No. 10-2016-0007609, filed on Jan. 21, 2016 in the Korean Intellectual Property Office, the disclosure of which is incorporated herein by reference.

### TECHNICAL FIELD

Embodiments of the present disclosure relate to storage apparatuses and methods of controlling the same, and more particularly, to storage apparatuses and methods of controlling the same to receive or return a package, which should be stored at a controlled temperature, such as food, in a non-face to face manner using two doors open in opposite directions such that a delivery person and a consumer do not meet each other and to control cold storage and warm storage of the package by setting desired time and temperature.

### BACKGROUND

A refrigerator generally including a refrigeration compartment and a freezer compartment is an appliance used to keep food fresh for a long time by supplying cool air to the refrigeration and freezer compartments. A refrigeration process generally performed in the refrigerator includes cooling ambient air using latent heat generated during expansion of a refrigerant and circulating the cooled air using a blowing unit.

Refrigerators have been restricted in installation position and use thereof due to structural characteristics of the refrigerator. Particularly, general refrigerators require various devices such as a compressor and an evaporator used for the refrigeration process performed using a refrigerant and a space therefor. Thus, it is difficult to minimize and simplify the refrigerators and cannot be installed at a specified position.

In general, packages including food, and the like are delivered to homes, offices, hotels, or the like, via inlets provided at front doors. Although food such as milk, yogurt, and fruit, should be stored at low temperature to be kept fresh, food delivered to an empty house, people of which are out or absent on a trip for a long time, is kept at room temperature and decomposes, particularly, in summer. Thus, there is a need to develop a refrigerator installed at a front door or an external wall of the house adjacent to the front door and capable of storing delivered food in a fresh state. However, development thereof is difficult due to restrictions in size and structure as described above.

Also, there is a need to enhance security between the delivery person and the user when the food, or the like, is delivered by the delivery person or returned by the user and to decrease power conduction to keep food fresh.

### SUMMARY

To address the above-discussed deficiencies, it is a primary object to provide a storage apparatus and a method of controlling the same to receive or return a package, which should be stored at a controlled temperature, such as food, in a non-face to face manner using two doors open in opposite directions such that a delivery person and a consumer do not meet each other and to control cold storage and warm storage of the package by a storage temperature or storage time for the package from the outside even when the consumer cannot immediately pick up the package.

Additional aspects of the disclosure will be set forth in part in the description which follows and, in part, will be obvious from the description, or may be learned by practice of the disclosure.

In accordance with one aspect of the present disclosure, a storage apparatus includes: a first door; a second door provided to face the first door; an imaging device configured to acquire an image of the package accommodated in the storage apparatus; a communicator configured to transmit the acquired image of the package to an external device; and a controller configured to control a storage temperature for the package in accordance with a package storage temperature set by the external device based on the image of the package.

The storage apparatus may further include: a weight sensor configured to sense a weight of the package accommodated in the storage apparatus.

The controller may determine that the package is introduced into the storage apparatus when the weight of the package is sensed by the weight sensor and that the package is taken out of the storage apparatus when the weight of the package is not sensed by the weight sensor.

The imaging device may acquire an image of the inside of the storage apparatus based on whether or not the weight of the package is sensed by the weight sensor.

The imaging device may include: an internal imaging device configured to acquire an image of the inside of the storage apparatus; and an external imaging device configured to acquire an image of the outside of the storage apparatus.

The first door may be not opened when the second door is opened, and the second door is not opened when the first door is opened.

The storage apparatus may further include: a temperature sensor configured to sense an internal temperature of the storage apparatus.

The storage apparatus may further include: an identifier configured to recognize delivery information about the package accommodated in the storage apparatus.

The identifier may be disposed at the second door, and the second door may be opened when the identifier recognizes the delivery information about the package.

The identifier may recognize the delivery information about the package using at least one of a bar code, a QR code, text data, data matrix, a recognition pattern, NFC, RFID, iris recognition, and fingerprint recognition.

The delivery information about the package may include at least one of a type of the package, a storage temperature for the package, a package arrival time, and information about a delivery person of the package.

The communicator may transmit the delivery information about the package recognized by the identifier to the external device.

The controller may perform a cold storage control or a warm storage control for the package to adjust the internal temperature of the storage apparatus sensed by the temperature sensor to reach a cold storage temperature or a warm storage temperature set by the external device.

The controller may perform a cold storage control or a warm storage control for the package based on a cold storage time or a warm storage time for the package set by the external device.

The controller may send out a notification signal after the cold storage time or the warm storage time set by the external device elapsed.

The controller may stop the cold storage control or the warm storage control when the weight of the package is not sensed by the weight sensor.

The first door may include a first display, the first display may display at least one of delivery information about the package, cold storage information about the package, and warm storage information about the package.

The second door may include a second display, the second display may display delivery information about the package.

In accordance with another aspect of the present disclosure, a storage apparatus includes: a first door; a second door provided to face the first door; an identifier configured to recognize delivery information about the package accommodated in the storage apparatus; a communicator configured to transmit the recognized delivery information about the package to an external device; and a controller configured to control at least one of a storage temperature and a storage time for the package in accordance with at least one of a package storage temperature and a package storage time set by the external device based on the transmitted delivery information about the package.

In accordance with another aspect of the present disclosure, a storage apparatus includes: a first door; a second door provided to face the first door; an identifier configured to recognize delivery information about the package accommodated in the storage apparatus; and a controller configured to set at least one of a package storage temperature and a package storage time based on the recognized delivery information about the package and control at least one of a storage temperature and a storage time for the package based on the settings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view of one side of a storage apparatus according to various embodiments of the present disclosure;

FIG. 2 illustrates a view of the other side of the storage apparatus according to various embodiments of the present disclosure;

FIG. 3 illustrates a view of the storage apparatus installed at a wall separating indoor and outdoor spaces and connecting the indoor and outdoor spaces according to various embodiments of the present disclosure;

FIGS. 4 and 5 illustrate views of the inside of a storage apparatus according to various embodiments of the present disclosure;

FIG. 6 illustrates a block diagram of a control flow of a storage apparatus according to various embodiments of the present disclosure;

FIG. 7 illustrates a view of a package delivered and stored in a storage apparatus according to various embodiments of the present disclosure;

FIGS. 8 and 9 illustrate views of images of a package and delivery information about the package displayed on an external device according to various embodiments of the present disclosure;

FIG. 10 illustrates a view for describing setting of a storage temperature of a package by an external device according to various embodiments of the present disclosure;

FIG. 11 illustrates a view of an image of a package and delivery information about the package displayed on a first display according to various embodiments of the present disclosure;

FIG. 12 illustrates a view of a package to be returned stored in a storage apparatus according to various embodiments of the present disclosure;

FIG. 13 illustrates view for describing setting of a storage temperature of a package is set by an external device in case of returning the package according to various embodiments of the present disclosure;

FIG. 14 illustrates a view of an external device displaying a message confirming receipt of a return of a package when the package is returned according to various embodiments of the present disclosure;

FIG. 15 illustrates a view of a first display displaying a message confirming receipt of a return of a package when the package is returned according to various embodiments of the present disclosure;

FIG. 16 illustrates a perspective view of a storage apparatus connected to a general refrigerator according to various embodiments of the present disclosure; and

FIGS. 17 to 19 illustrate flowcharts of methods of controlling a storage apparatus according to various embodiments of the present disclosure.

### DETAILED DESCRIPTION

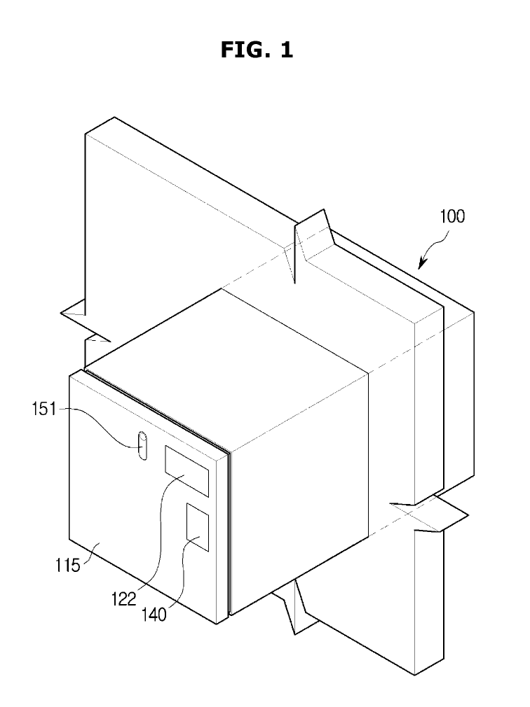

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

Reference will now be made in detail to the embodiments of the present disclosure, examples of which are illustrated in the accompanying drawings, wherein like reference numerals refer to like elements throughout. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art.

The terms used in the specification will be described briefly, and then embodiments will be described in detail.

The terms used in this specification are selected from currently widely used general terms in consideration of functions of the present disclosure, but may vary according to the intentions or practices of those skilled in the art or the advent of new technology. Additionally, in certain cases, there may be terms that an applicant may arbitrarily select, and in this case, their meanings are described below. Accordingly, the terms used in this specification should be interpreted on the basis of substantial implications that the terms have and the contents across this specification not the simple names of the terms.

Throughout the specification, the term “include” an element do not preclude the other elements but further includes an element unless otherwise stated. In addition, the term “unit” as used herein, refers to, but is not limited to, a software component or a hardware component such as a FPGA or ASIC and performs certain tasks. A unit may be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

Hereinafter, a storage apparatus and a method of controlling the same according to an embodiment will be described in detail with reference to the attached drawings. In the drawings, parts unrelated to the descriptions are omitted for clear description of the disclosure. Like reference numerals denote like elements, and repeated descriptions thereof will not be given.

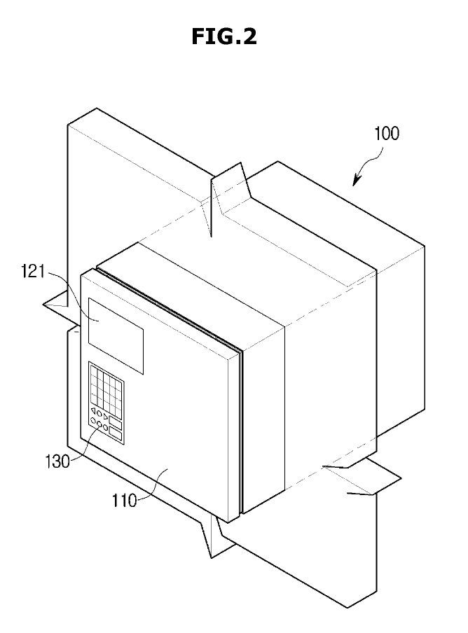

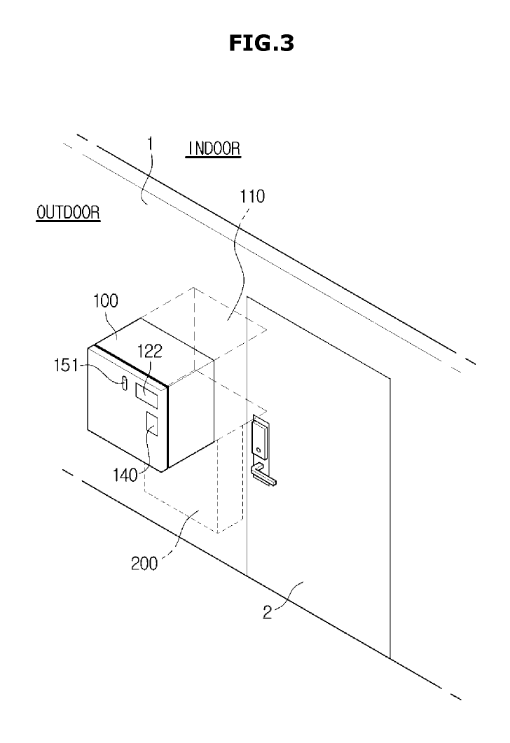

FIG. 1 illustrates a view of one side of a storage apparatus according to an embodiment. FIG. 2 illustrates a view of the other side of the storage apparatus. FIG. 3 illustrates a view of the storage apparatus installed at a wall separating indoor and outdoor spaces and connecting the indoor and outdoor spaces.

A storage apparatus 100 according to an embodiment may have the same configuration as a general refrigerator and may include a storage compartment configured to accommodate a package such as food. In addition, the ‘package’ will be exemplarily described as a package required to be kept fresh under a predetermined temperature such as food and groceries. However, the package is not limited to food or groceries, and any package accommodatable in the storage apparatus 100 may also be used.

The storage apparatus 100 may keep the package accommodated in the storage apparatus 100 under cold or warm storage conditions, and cold storage may include freeze storage. Thus, a cold storage/warm storage control unit configured to keep the package accommodated in the storage apparatus 100 under cold or warm storage conditions may be installed inside the storage apparatus 100 or disposed outside the storage apparatus 100 to be connected to the storage apparatus 100.

Although a storage apparatus 100 having a cuboid shape will be exemplarily described for descriptive convenience, the shape of the storage apparatus 100 is not limited thereto.

Also, the term “delivery person” described hereinafter refers to a person to deliver packages such as articles or food and may include a person preregistered as the delivery person such as a package delivery person and a mailperson.

As illustrated in FIGS. 1 and 2, the storage apparatus 100 according to an embodiment may include a pair of first door 110 and second door 115, a first display 121, a second display 122, an inputter 130, an identifier 140, and an external imaging device 151.

The first door 110 and the second door 115 may be provided to face each other and may be opened and closed vertically or horizontally. The first door 110 and the second door 115 may be rotatably hinged to a body of the storage apparatus 100 and may include an elastic member installed at hinges to support the first door 110 and the second door 115.

Although the shapes of the first door 110 and the second door 115 and methods of opening and closing the same are not limited, the first door 110 cannot be opened when the second door 115 is opened, and the second door 115 cannot be opened when the first door 110 is opened. That is, the first door 110 and the second door 115 may be opened and closed in accordance with electronic control of the controller 105, and both of the first door 110 and the second door 115 are not simultaneously opened.

Since the first door 110 and the second door 115 are not simultaneously opened, a packaged may be delivered and returned in a non-face to face manner such that a delivery person delivering the package and a consumer picking up the package do not meet. Thus, invasion of a robbery disguised as the delivery person may be prevented, thereby improving security.

Also, the second door 115 may be opened only when the identifier 140 recognizes delivery information about the package by the delivery person and cannot be opened by any other methods.

As illustrated in FIG. 3, the storage apparatus 100 may be installed to penetrate a wall 1 separating indoor and outdoor spaces. That is, the storage apparatus 100 may be inserted into the wall 1 at which a front door 2 is installed. The first door 110 disposed at one side of the storage apparatus 100 may be installed to face the indoor space with respect to the wall 1, and the second door 115 disposed at the other side of the storage apparatus 100 may be installed to face the outdoor space with respect to the wall 1. A cold storage/warm storage control unit 200 configured to store the package accommodated in the storage apparatus 100 under cold or warm storage conditions as described above may be disposed under the storage apparatus 100 to supply cooled air to cool the storage apparatus 100 or warm air to warm up the storage apparatus 100 into a storage compartment of the storage apparatus 100.

The storage apparatus 100, different from that illustrated in FIG. 3, may also be installed to penetrate the front door 2. The indoor space where the storage apparatus 100 penetrating the wall 1 is installed may be any space such as kitchen or living room. That is, the storage apparatus 100 may be installed at any position in a space penetrating the wall 1 and connecting the indoor and outdoor spaces.

Since the storage apparatus 100 is installed to penetrate the wall 1 separating indoor and outdoor spaces as described above, a consumer staying in a house may easily pick up the package, delivered by the delivery person and accommodated in the storage apparatus 100, by simply opening the first door 110.

In addition, in case of room services providing an article or food to a client staying in a hotel room, the client may easily pick up the article or food by simply opening the first door 110 of the storage apparatus 100 in the hotel room.

The package accommodated in the storage apparatus 100 may be provided to the consumer or client in a fresh state kept at an appropriate temperature therefor in accordance with a control method according to an embodiment, which will be described later.

Referring to FIG. 1, the storage apparatus 100 may include the second door 115 installed on the side facing the outdoor space with respect to the wall 1, and the second door 115 may include the second display 122, the identifier 140, and the external imaging device 151.

The second display 122 may display delivery information about the package delivered by the delivery person. That is, when the delivery person delivers the package, the identifier 140 may recognize delivery information about the package, and the recognized delivery information may be displayed on the second display 122. The delivery person may identify whether delivery information about the package is accurately displayed via the second display 122.

Delivery information about the package may include a type of the package, an appropriate storage temperature for the package, a package arrival time, and information about a delivery person of the package.

Also, a screen related to operation of the storage apparatus 100 may be displayed on the second display 122. For example, the second door 115 cannot be opened when the first door 110 is opened. Thus, the second display 122 may display a message notifying that the second door 115 cannot be opened due to the opened first door 110 in case the first door 110 is opened.

The second display 122 may be implemented using a display device such as liquid crystal display (LCD), light emitting diode (LED), organic light emitting diode (OLED), active matrix organic light emitting diode (AMOLED), flexible display, and 3D display. In addition, the second display 122 may include a touch panel to receive a touch command from a user, and the shape and installation position of the second display 122 are not limited.

The identifier 140 may recognize delivery information about the package accommodated in the storage apparatus 100 using at least one of a bar code, a QR code, text data, data matrix, a recognition pattern, NFC, RFID, iris recognition, and fingerprint recognition. The shape and installation position of the identifier 140 are not limited.

The external imaging device 151 may be disposed at the second door 115 to acquire an image of the outside the second door 115. That is, if the delivery person delivers the package, the external imaging device 151 may acquire images of the delivery person and the delivered package. The external imaging device 151 may photograph the outside of the second door 115 or record the outside of the second door 115 as a video. The external imaging device 151 may be implemented using camera modules commonly used in the art.

Referring to FIG. 2, the storage apparatus 100 may include the first door 110 installed at one side facing the indoor space with respect to the wall 1, and the first door 110 may include the first display 121 and the inputter 130.

The first display 121 may display at least one of delivery information about the package, cold storage information of the package, and warm storage information of the package. That is, the user staying in the house may identify the type of the delivered package, the appropriate storage temperature for the package, the package arrival time, information of the delivery person, cold storage temperature of the package, or information about warm storage of the package via the first display 121.

Also, the first display 121 may display a screen related to operation of the storage apparatus 100. For example, the first door 110 cannot be opened when second door 115 is opened. Thus, the first display 121 may display a message notifying that the first door 110 cannot be opened due to the opened second door 115 in case the second door 115 is opened.

The first display 121 may be implemented using a display device such as liquid crystal display (LCD), light emitting diode (LED), organic light emitting diode (OLED), active matrix organic light emitting diode (AMOLED), flexible display, and 3D display. In addition, the first display 121 may include a touch panel to receive a touch command from the user, and the shape and installation position of the first display 121 are not limited.

The user may input a command related to control of the storage apparatus 100 via the inputter 130. That is, the user may input a control command to open the first door 110 after identifying the delivered package and a control command to store the package accommodated in the storage apparatus 100 under cold or warm storage conditions. Particularly, the user may input a cold or warm storage temperature or a cold or warm storage time to store the package via the inputter 130.

The inputter 130 may include mechanical buttons or may be a touchscreen to receive a touch command using a touch panel, and the shape and installation position of the inputter 130 are not limited.

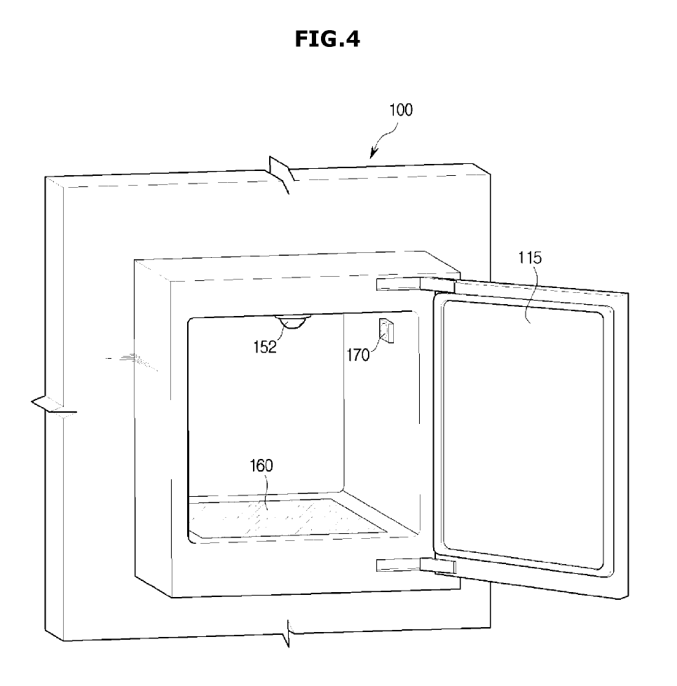

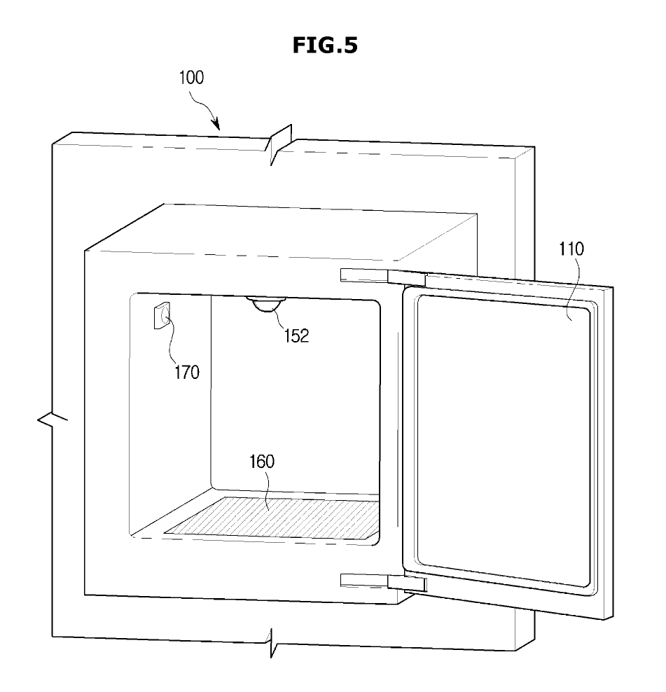

FIGS. 4 and 5 illustrate views of the inside of a storage apparatus according to an embodiment.

Referring to FIGS. 4 and 5, the inside of the storage apparatus 100 are provided with an internal imaging device 152, a weight sensor 160, and a temperature sensor 170.

The internal imaging device 152 disposed in the storage apparatus 100 may acquire an image of the inside of the storage apparatus 100. That is, when the package is delivered and located in the storage apparatus 100, the internal imaging device 152 may acquire an image of the package located in the storage apparatus 100. When the delivery person picks up the package to return the package, the internal imaging device 152 may acquire an image of the inside of the storage apparatus 100 from which the package is removed.

The internal imaging device 152 may take a photograph of the inside of the storage apparatus 100 or continuously records the inside of the storage apparatus 100 as a video when the package is introduced into or removed from the storage apparatus 100.

The internal imaging device 152 may acquire an image of the inside of the storage apparatus 100 based on weight sensing of the package by the weight sensor 160. The image of the package may be acquired at a time when the weight sensor 160 senses the weight of the package or the image of the inside of the storage apparatus 100 may be acquired at a time when the weight of the package is not sensed by the weight sensor 160.

The photograph or video acquired by the internal imaging device 152 may be transmitted to the user to identify the delivered package, which will be described later.

Imaging methods or imaging times of the internal imaging device 152 may vary depending on settings by the user, and the internal imaging device 152 may be implemented using any camera module commonly used in the art with no restrictions on the shape and installation position thereof.

The weight sensor 160 may sense a weight of the package accommodated in the storage apparatus 100. Particularly, if the package is located in the storage apparatus 100, the weight sensor 160 may sense the weight of the package. Based on the sensing result, information indicating that the package is delivered and located in the storage apparatus 100 may be transmitted to the user.

On the contrary, if the package stored in the storage apparatus 100 is picked up by the delivery person, the weight of the package cannot be sensed by the weight sensor 160. Based on the sensing result, information indicating that the package has been picked up by the delivery person is transmitted to the user. The shape and installation position of the weight sensor 160 are not limited.

The temperature sensor 170 may sense an internal temperature of the storage apparatus 100. In order to keep the package accommodated in the storage apparatus 100 fresh at an appropriate temperature for cold or warm storage, there is a need to sense the internal temperature of the storage apparatus 100 in real time and adjust the internal temperature of the storage apparatus 100 to the appropriate storage temperature for the package.

Thus, the temperature sensor 170 may sense changes in the internal temperature of storage apparatus 100 in real time and send out an electric signal corresponding thereto. The temperature sensor 170 may be disposed at any position capable of sensing the internal temperature of the storage apparatus 100 and may include a thermistor having electric resistance that changes depending on temperature.

The interior of the storage apparatus 100 may be formed of a thermal conductive material, for example, a metallic material such as aluminum. In addition, the interior of the storage apparatus 100 may be filled with a heat shield material to maintain the internal temperature of the storage apparatus 100 at a constant level.

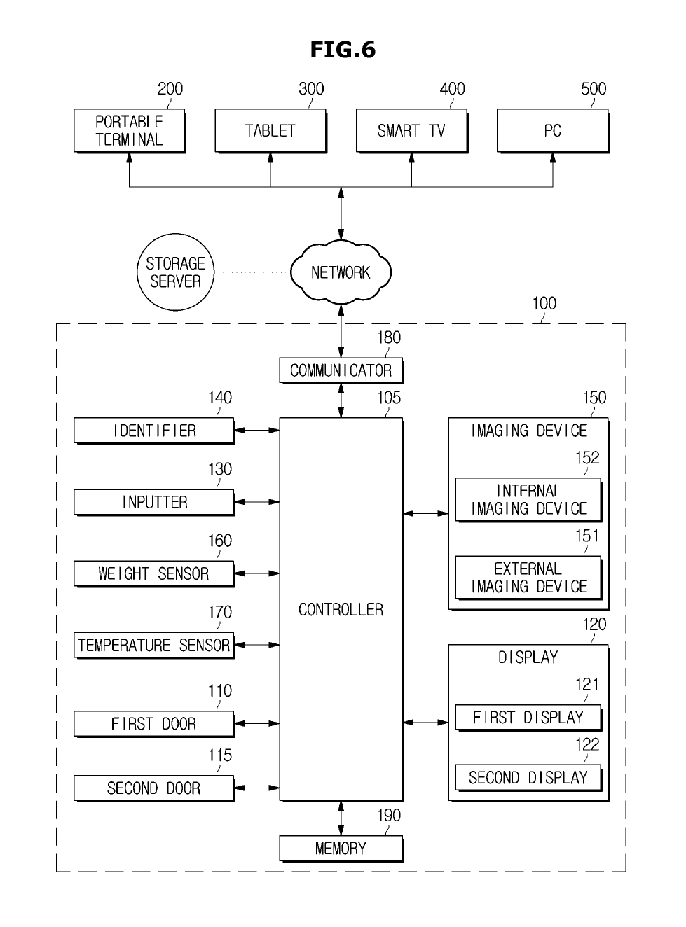

FIG. 6 illustrates a block diagram of a control flow of a storage apparatus according to an embodiment.

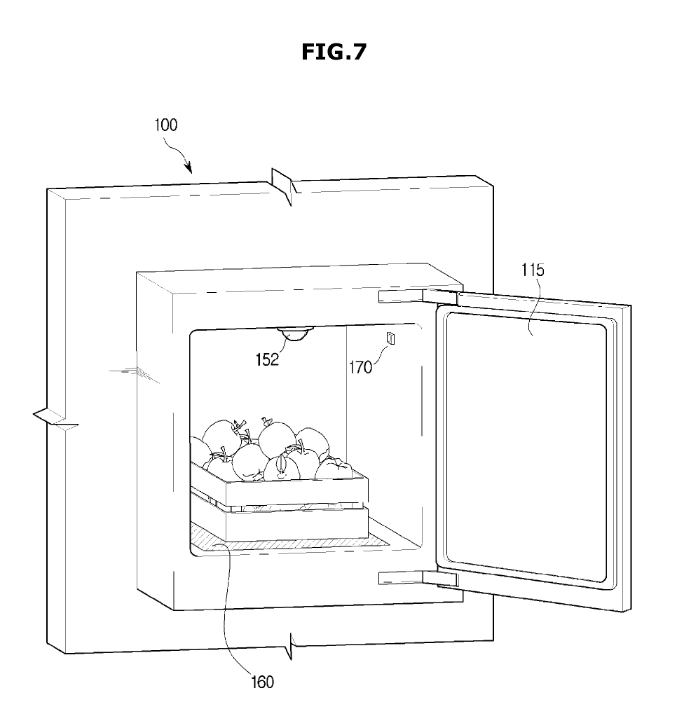

Hereinafter, the control flow according to an embodiment will be described with reference to FIGS. 7 to 15.

FIG. 7 illustrates a view of a package delivered and stored in a storage apparatus according to an embodiment.

The delivery person delivering a package may allow the identifier 140 to recognize delivery information about the package to open the second door 115 of the storage apparatus 100. As described above, the identifier 140 may recognize delivery information about the package by using at least one of a bar code, a QR code, text data, data matrix, a recognition pattern, NFC, RFID, iris recognition, and fingerprint recognition. For example, the delivery person may transmit delivery information about the package to the storage apparatus 100 by bringing a pre-registered identification card into contact with the identifier 140.

Delivery information about the package recognized by the identifier 140 may be displayed on the second display 122 disposed at the second door 115, and the external imaging device 151 may acquire images of the delivery person and the package.

When identifier 140 recognizes delivery information about the package, the controller 105 may send out a control signal to open the second door 115 simultaneously sending out a control signal not to open the first door 110. Also, the identifier 140 may transmit the obtained delivery information about the package to the controller 105, and the controller 105 may control a communicator 180 to transmit the delivery information about the package to an external device.

In this case, the external device may include any device available by the user outside the storage apparatus 100 and include at least one of a portable terminal 200, a tablet 300, a smart TV 400, and a PC 500. The user may control cold or warm storage of the storage apparatus 100 outside the house or hotel room via the external device. Hereinafter, an embodiment will be exemplarily described using the portable terminal 200 as the external device.

When the second door 115 of the storage apparatus 100 is opened, the delivery person may place the delivered package in the storage apparatus 100. FIG. 7 exemplarily illustrates apples as the delivered package.

When the package is accommodated in the storage apparatus 100, the weight sensor 160 placed in the storage apparatus 100 may sense a weight of the package and transmit a signal corresponding to the sensed weight of the package to the controller 105.

Upon receiving the signal from the weight sensor 160, the controller 105 may determine that the package is introduced into the storage apparatus 100.

The internal imaging device 152 may acquire an image of the package accommodated in the storage apparatus 100, and the image may be a photograph or a video acquired by recording the accommodated state of the package.

In addition, when the weight sensor 160 senses the weight of the package and transmits the signal to the controller 105, the controller 105 may determine that the package is introduced into the storage apparatus 100, and transmit a control signal to control the internal imaging device 152 to acquire an image of the package located in the storage apparatus 100 at the same time.

The temperature sensor 170 may sense an internal temperature of the storage apparatus 100 in which the package is accommodated and transmit an electric signal corresponding to the sensed temperature to the controller 105, and the controller 105 may determine a current internal temperature or a change in the internal temperature based on the received electric signal.

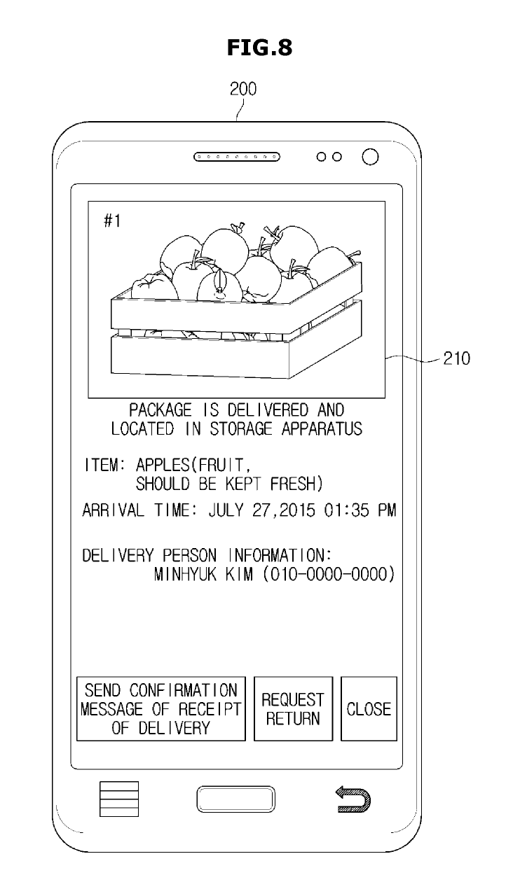

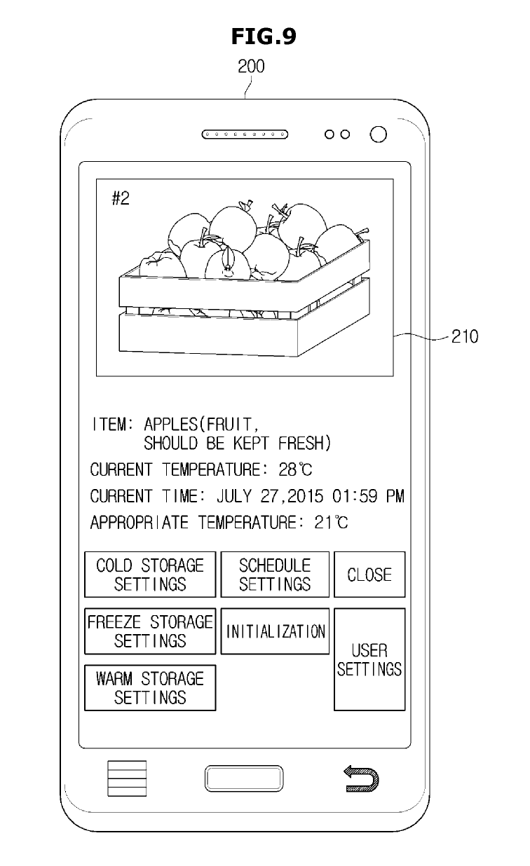

FIGS. 8 and 9 illustrate views of images of a package and delivery information about the package displayed on an external device according to an embodiment.

The internal imaging device 152 may acquire an image of the package accommodated in the storage apparatus 100. Acquired image data may be transmitted to the external device via the communicator 180, and delivery information about the package recognized by the identifier 140 may also be transmitted to the external device via the communicator 180. FIG. 8 illustrates a screen of the portable terminal 200, as the external device, displaying an image of the package and delivery information about the package.

The communicator 180 may transmit/receive information to/from the external device via a network, retrieve information from an external storage server, or store information in the storage server.

The communicator 180 may include at least one of a Bluetooth communication module that performs ono-to-one communications with a single external device or one-to-multi communications with a plurality of external devices, a wireless fidelity (Wi-Fi) communication module that accesses a local area network (LAN) via a wireless access point, and a local area communication module such as a ZIGBEE communication module that forms a LAN between the storage apparatus 100 and the external device. However, the communication module included in the communicator 180 is not limited to the Bluetooth communication module, the Wi-Fi communication module, and the local area communication module, and any other communication modules performing communications in accordance with various communication protocols may also be used.

As illustrated in FIG. 8, an image 210 of the package delivered by the delivery person and accommodated in the storage apparatus 100 may be displayed on the screen of the portable terminal 200. Accordingly, the user may identify the type of the delivered package and storage state thereof via the portable terminal 200 even when the user is out.

In addition, delivery information about the package recognized by the identifier 140 may also be displayed on the screen of the portable terminal 200. Particularly, the type of the delivered package, the package arrival time, information about the package delivery person, and the like are displayed thereon to allow the user to confirm delivery information about the package.

After identifying the image 210 of the delivered package and delivery information about the package, the user may send a message confirming receipt of the package or a message requesting a return of the package if required or if the package is misdelivered.

As illustrated in FIG. 9, the portable terminal 200 may display an appropriate storage temperature of the delivered package or a current temperature of the storage apparatus 100.

When the package is delivered and accommodated in the storage apparatus 100, the temperature sensor 170 may sense a current temperature of the storage apparatus 100 and transmit the sensing result to the controller 105, and the transmitted temperature information may be displayed on the screen of the portable terminal 200 via the communicator 180.

In addition, delivery information about the package recognized by the identifier 140 includes information about an appropriate storage temperature to keep the package accommodated in the storage apparatus 100 fresh, and the user may determine a cold storage temperature or a warm storage temperature of the storage apparatus 100 based on the appropriate storage temperature for the package displayed on the screen of the portable terminal 200.

The user may input a control command to the portable terminal 200, and the input control command may be transmitted to the controller 105 via the communicator 180 and used to control storage temperature or storage time of the storage apparatus 100.

Since the storage apparatus 100 may store the accommodated package under cold or warm storage conditions, the user may select one of cold storage, freeze storage, or warm storage based on the type of the package and the appropriate storage temperature therefor.

Referring to FIG. 9, while an appropriate storage temperature to keep the apples, as the package accommodated in the storage apparatus 100, fresh is 21° C., the current temperature of the storage apparatus 100 is 28° C. Thus, there is a need to perform a cold storage control by decreasing the temperature of the storage apparatus 100.

The user may input a control command to store the apples accommodated in the storage apparatus 100 under cold storage conditions via an interface displayed on the screen of the portable terminal 200.

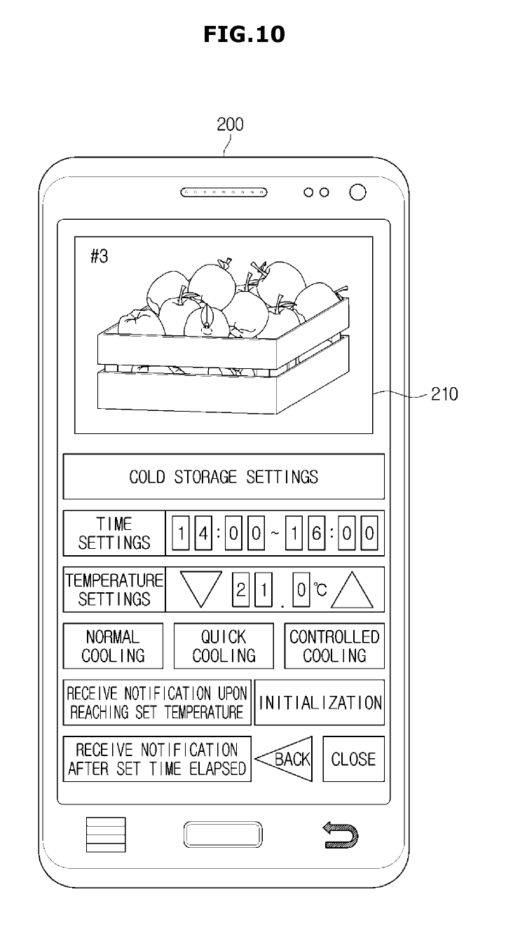

FIG. 10 is a view for describing setting of a storage temperature of a package by an external device according to an embodiment.

Referring to FIG. 10, the user may set a storage temperature and storage time for the package via an interface displayed on the screen of the portable terminal 200. The portable terminal 200 may include a touch panel to receive a touch input, and thus the user may input the control command by touching the portable terminal 200.

As illustrated in FIG. 10, the user may select cold storage settings for the package accommodated in the storage apparatus 100 and set the cold storage time of the package. That is, when the user is out and cannot pick up the package accommodated in the storage apparatus 100 immediately, the user may set the storage time and perform cold storage for the set storage time to keep he package fresh until the user picks up the package.

In addition, the user may set the cold storage temperature for the package. Since delivery information about the package includes an appropriate storage temperature for the package as described above with reference to FIG. 9, the user may set the storage temperature for the package based on the appropriate storage temperature thereof.

When the user sets the cold storage time and cold storage temperature for the package, the set information may be transmitted to the controller 105 of the storage apparatus 100 via the communicator 180, and the controller 105 may control the storage apparatus 100 to store the package accommodated therein under cold storage conditions based on the set time and temperature. That is, the controller 105 may perform cold storage control or warm storage control for the package such that the internal temperature of the storage apparatus 100 sensed by the temperature sensor 170 reaches the storage temperature set by the user.

If the user sets the cold storage time or warm storage time for the package, the storage apparatus 100 stores the package under cold or warm storage conditions during the time set by the user, thereby reducing power consumption and increasing energy efficiency.

In other words, although general refrigerators and warming cabinets continuously perform cold or warm storage for the package accommodated therein, the storage apparatus 100 according to an embodiment performs cold or warm storage only when the package is accommodated in the storage apparatus 100 for the time set by the user, resulting in reduction in energy consumption.

The user may also set intensity and type of the cold or warm storage in addition to the storage temperature or storage time for the package. When the internal temperature of the storage apparatus 100 reaches the temperature set by the user in accordance with the user's settings, the controller 105 may send out a control signal informing the user that the package is under storage based on the set temperature to the user.

Also, if the package accommodated in the storage apparatus 100 has not been picked up even after the storage time set by the user, the controller 105 may send out a control signal informing that the storage time set by the user elapsed.

Differently from descriptions with reference to FIGS. 8 to 10, although the user does not set the storage temperature and storage time for the package via the external device, the controller 105 of the storage apparatus 100 may control cold storage or warm storage for the package based on setting values preset by the user and stored in a memory 190.

Particularly, when the package is accommodated in the storage apparatus 100, the controller 105 may set the storage temperature and storage time for the package based on delivery information about the package acquired by the identifier 140 and start cold storage control or warm storage control. That is, if the appropriate storage temperature included in delivery information about the package acquired by the identifier 140 is 21° C., the controller 105 may set the cold storage temperature for the package as 21° C. based on data stored in the memory 190 and perform cold storage for the package for the preset storage time.

In addition, the controller 105 may not perform the cold storage control or warm storage control during a predetermined time after the package is accommodated in the storage apparatus 100 but start the cold storage control or warm storage control after the predetermined time. As the controller 105 performs the cold or warm storage based on the preset storage time, power may be efficiently consumed.

The memory 190 may store control programs or control data to control operation of the storage apparatus 100 or control command data output by the controller 105.

That is, the memory 190 may store delivery information about the package recognized by the identifier 140 and image data of the package or the inside of the storage apparatus 100 acquired by the external imaging device 151 and the internal imaging device 152.

Also, the memory 190 may store data about storage temperature and storage time for the package set by the user via the external device and data about internal temperature of the storage apparatus 100 sensed by the temperature sensor 170.

The memory 190 may include at least one type of storage medium selected from flash memory type, hard disk type, multimedia card micro type, card type memory (SD and XD memory), random access memory (RAM), static random access memory (SRAM), read-only memory (ROM), electrically erasable programmable read-only memory (EEPROM), programmable read-only memory (PROM), magnetic memory, magnetic disc, and optical disc.

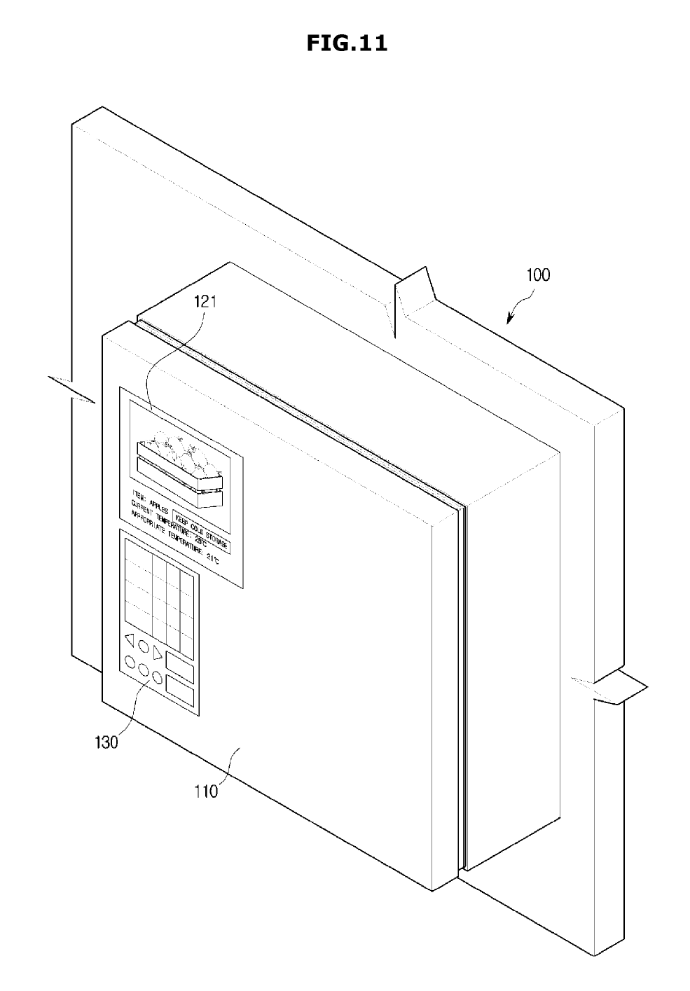

FIG. 11 illustrates a view of an image of a package and delivery information about the package displayed on a first display according to an embodiment.

Image data of the package acquired by the internal imaging device 152 and delivery data of the package recognized by the identifier 140 may be displayed on the first display 121 under the control of the controller 105.

Since the first display 121 is disposed at the first door 110 of the storage apparatus 100, the user staying in the house may identify a photograph or video of the package accommodated in the storage apparatus 100 or data related to a storage state of the package via the screen of the first display 121.

As illustrated in FIG. 11, if the package delivered and accommodated in the storage apparatus 100 is apples, the user may identify the photograph or video of the apples acquired by the internal imaging device 152, 28° C. as a current internal temperature of the storage apparatus 100, and 21° C. as an appropriate storage temperature for the applies.

The user may input a cold storage temperature or warm storage temperature and a cold storage time or warm storage time for cold or warm storage of the package via the inputter 130.

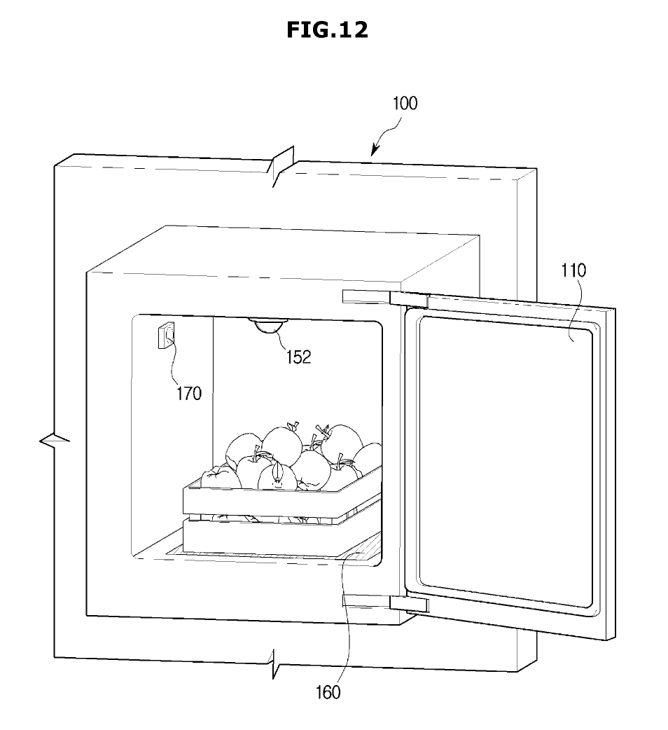

FIG. 12 illustrates a view of a package to be returned stored in a storage apparatus according to an embodiment.

The user may open the first door 110 of the storage apparatus 100 to return the package. When the user inputs a control command to open the first door 110 via the inputter 130 or the external device, the controller 105 may send out a control signal to open the first door 110 simultaneously sending out a control signal not to open the second door 115.

When the first door 110 of the storage apparatus 100 is opened, the user may place the package to be returned in the storage apparatus 100. When the package is stored in the storage apparatus 100, the weight sensor 160 provided in the storage apparatus 100 may sense a weight of the package and transmit a sensing signal to the controller 105.

Upon receiving the sensing signal from the weight sensor 160, the controller 105 may determine that the package is introduced into the storage apparatus 100.

The internal imaging device 152 may acquire an image of the package accommodated in the storage apparatus 100. The temperature sensor 170 may sense an internal temperature of the storage apparatus 100 in which the package is accommodated and transmit an electric signal corresponding to the sensed temperature to the controller 105. The controller 105 may determine a current internal of the storage apparatus 100 and a change in the temperature thereof based on the received signal.

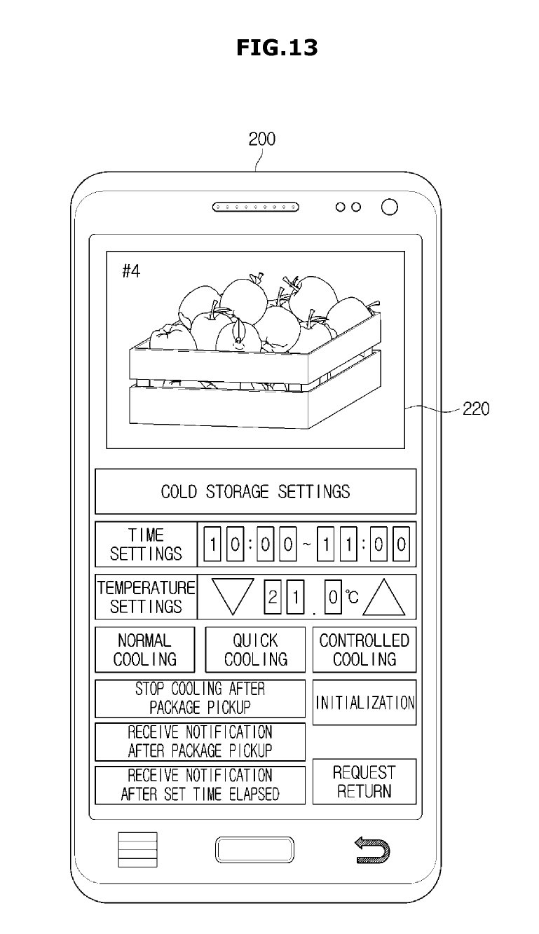

FIG. 13 illustrates for describing setting of a storage temperature of a package is set by an external device according to an embodiment in case of returning the package.

In case of returning the package, the user may place the package in the storage apparatus 100 and go out. Thus, there is a need to store the package under cold or warm storage conditions until the delivery person picks up the package. In this case, the user may input a control command to control a storage temperature and storage time for the package via the external device such that the package is kept fresh while being accommodated in the storage apparatus 100.

Referring to FIG. 13, the user may set the storage temperature and storage time for the package via the interface displayed on the screen of the portable terminal 200. As illustrated in FIG. 13, the user may select cold storage settings for the package accommodated in the storage apparatus 100 and set the cold storage time for the package. That is, if the user places the package in the storage apparatus 100 and goes out, the storage time may be set and cold storage may be performed for the set storage time to keep the package fresh until the delivery person picks up the package to be returned.

Also, the user may set a cold storage temperature for the package. As described above, delivery information about the package includes an appropriate storage temperature for the package, and thus the user may set the storage temperature based on the appropriate storage temperature for the package.

In case of returning the package, the user may set the storage temperature and storage time for the package via the inputter 130 disposed at the first door 110. However, it there is a need to change the set temperature and time or additional settings are required after the preset time elapsed, the user staying outside the house may input a control command regarding the storage temperature and storage time for the package via the portable terminal 200.

When the user sets the cold storage time and cold storage temperature for the package, the set information may be transmitted to the controller 105 of the storage apparatus 100 via the communicator 180. The controller 105 may control the storage apparatus 100 to store the package accommodated therein under cold storage conditions based on the time and temperature set by the user.

The controller 105 may perform cold storage control or warm storage control for the package such that the internal temperature of the storage apparatus 100 sensed by the temperature sensor 170 reaches the set storage temperature.

If the user sets the cold storage time or warm storage time for the package, the storage apparatus 100 stores the package under cold or warm storage conditions during the time set by the user. Thus, there is no need to continuously perform the cold storage control or warm storage control, thereby reducing power consumption.

The user may also set the intensity and type of the cold or warm storage in case of returning the package and set the controller 105 to stop the cold or warm storage when the delivery person picks up the package accommodated in the storage apparatus 100.

In addition, when the delivery person picks up the package accommodated in the storage apparatus 100, the controller 105 may transmit a signal informing the user that the package has been picked up. If the package accommodated in the storage apparatus 100 has not been picked up even after the storage time set by the user, the controller 105 may send out a control signal informing that the storage time elapsed.

As the user places the package to be returned in the storage apparatus 100 and sets the temperature and time of cold storage or warm storage for the package accommodated in the storage apparatus 100 by the external device while staying outside the house, the package may be kept fresh until the delivery person picks up the package even when the user is out.

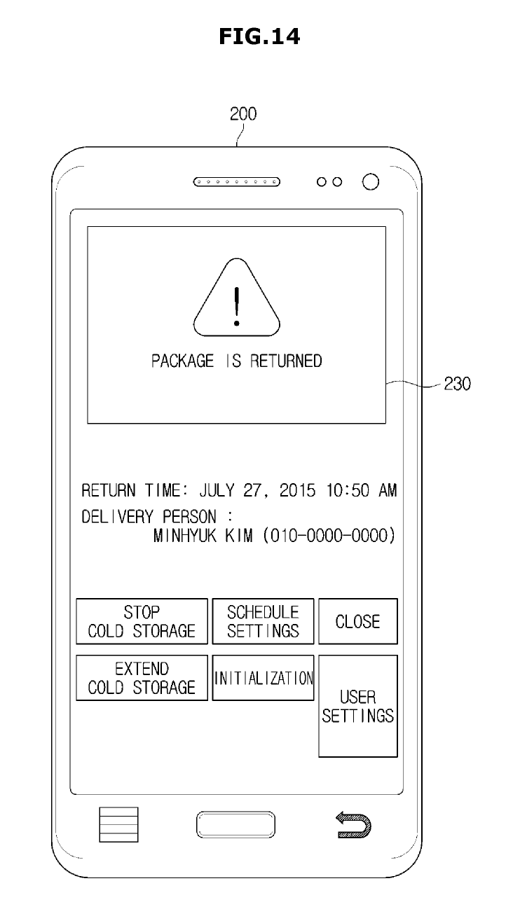

FIG. 14 illustrates a view of an external device displaying a message confirming receipt of a return of a package when the package is returned according to an embodiment.

The delivery person may allow the identifier 140 to recognize delivery information about the package to pick up the package accommodated in the storage apparatus 100, and then the second door 115 of the storage apparatus 100 is opened.

The delivery person may pick up the package accommodated in the storage apparatus 100. After the package is picked up, the weight of the package cannot be sensed by the weight sensor 160, and thus a control signal indicating no sensing result may be transmitted to the controller 105. The controller 105 may determine that the package is removed from the storage apparatus 100 if no sensing result is obtained by the weight sensor 160.

The internal imaging device 152 may acquire a photograph or video of the inside of the storage apparatus 100 from which the package is removed and transmit the photograph or video to the external device. The portable terminal 200 may display a message informing that the package has been picked up as illustrated in FIG. 14, and the user may identify that the package is normally returned via the display screen of the portable terminal 200. In addition, the portable terminal 200 may also display a package pickup time and information about the delivery person who picked up the package in addition to the message confirming receipt of the return of the package.

After the package is picked up, the controller 105 may determine that the package is taken out of the storage apparatus 100 and send out a control signal to stop cold or warm storage of the storage apparatus 100. That is, while the package is not stored in the storage apparatus 100, cold or warm storage is not performed, thereby reducing power consumption.

Upon confirming the message informing the return of the package, the user may control the controller 105 of the storage apparatus 100 to stop the cold or warm storage or extend the cold or warm storage time. The controller 105 of the storage apparatus 100 may perform cold or warm storage control of the storage apparatus 100 in accordance with values set by the user via the external device.

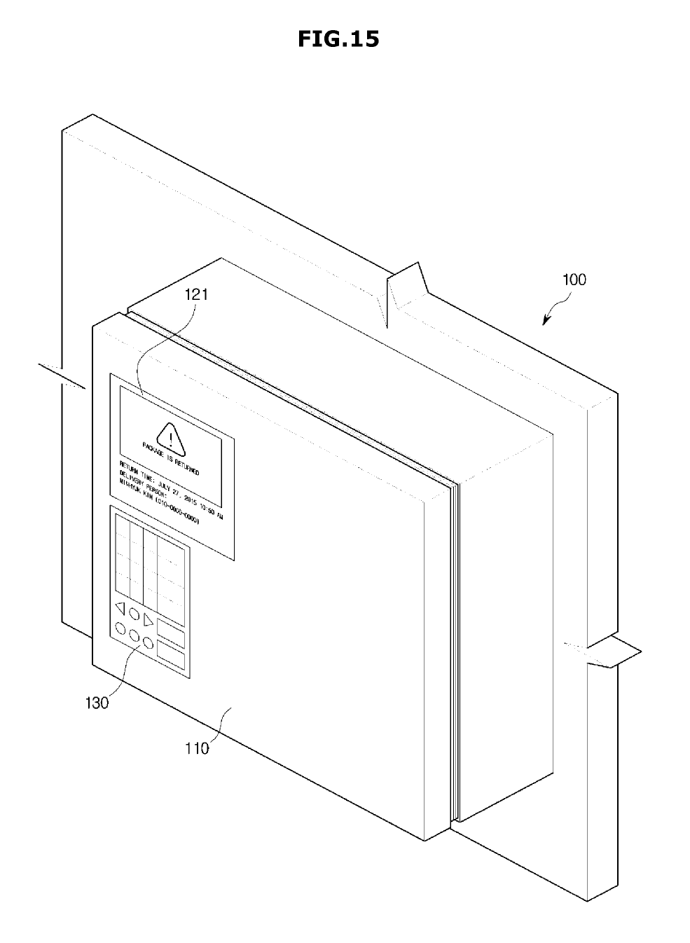

FIG. 15 illustrates a view of a first display displaying a message confirming receipt of a return of a package when the package is returned according to an embodiment.

In case of returning the package accommodated in the storage apparatus 100, the first display 121 may display image data of the inside of the storage apparatus 100 obtained by the internal imaging device 152 and a message notifying that the package is picked up. In addition, the first display 121 may also display a package pickup time and information about the delivery person who picked up the package in addition to the message confirming receipt of the return of the package.

Since the first display 121 is disposed at the first door 110 of the storage apparatus 100, the user staying in the house may identify whether the package is normally returned via the screen of the first display 121 in case of returning the package.

The user may input a control command to stop the cold or warm storage control of the storage apparatus 100 via the inputter 130 upon returning the package.

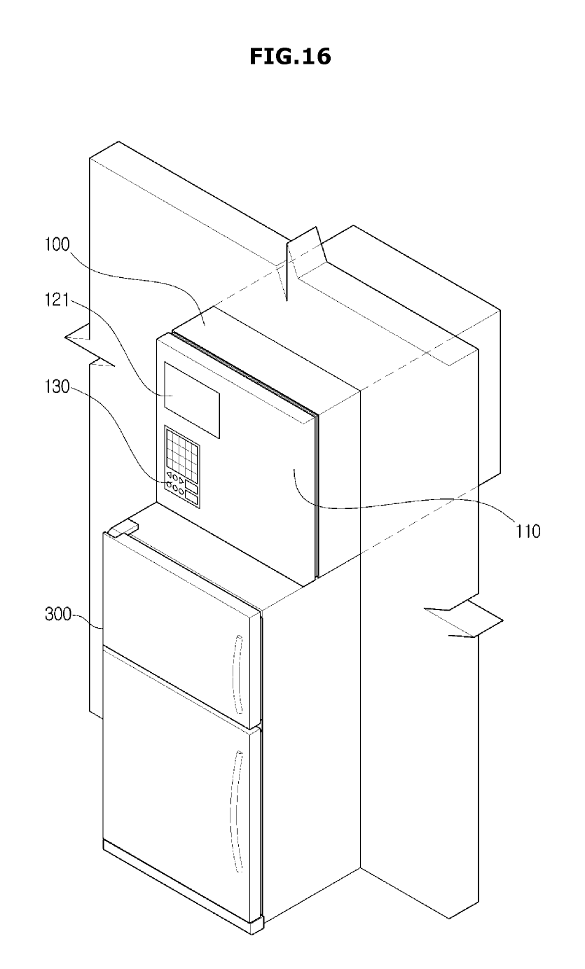

FIG. 16 illustrates a perspective view of that a storage apparatus according to an embodiment is connected to a general refrigerator.

As illustrated in FIG. 16, although the storage apparatus 100 according to an embodiment may be used alone as illustrated in FIGS. 1 to 3, the storage apparatus 100 may also be provided in a state of being connected to a general refrigerator 300 as illustrated in FIG. 16.

That is, since both the first door 110 side of the storage apparatus 100 and the refrigerator 300 are disposed inside the wall 1 separating indoor and outdoor spaces, the storage apparatus 100 may be connected to the refrigerator 300 as illustrated in FIG. 16, and the cold storage control of the storage apparatus 100 may be performed by a refrigeration device used in the refrigerator 300.

The user may place the package in the refrigerator 300 connected to the storage apparatus 100 immediately after taking the delivered package out of the storage apparatus 100. As a result, the package may be kept fresh and manufacturing costs may be reduced as the refrigerator 300 and the storage apparatus 100 may share the refrigeration device.

While the general refrigerator 300 continuously performs refrigeration for the accommodated package, the storage apparatus 100 according to an embodiment performs cold storage control only when the package is accommodated therein. Thus, the controller 105 may control the refrigeration device to perform the cold storage only when the package is accommodated in accordance with settings by the user or the control command from the user.

Although FIG. 16 illustrates the storage apparatus 100 disposed at a top surface of the refrigerator 300, the configuration of connecting the storage apparatus 100 and the refrigerator 300 may vary. The storage apparatus 100 may have any shape and be installed at any position of the refrigerator 300 such as at the top surface or a side surface enabling sharing of the refrigeration device.

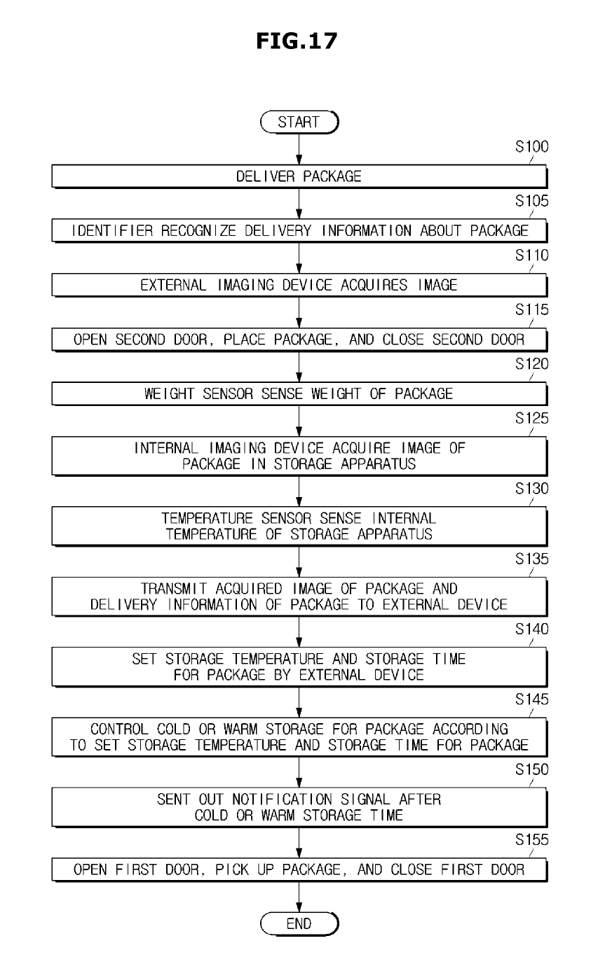

FIGS. 17 to 19 illustrate flowcharts of methods of controlling a storage apparatus according to an embodiment.

Referring to FIG. 17, the delivery person may deliver a package in operation S100. That is, the delivery person may deliver the package to a house or a hotel room. When there is no one in the house or hotel room, the package may be stored in the storage apparatus 100.

The delivery person who delivers the package may allow the identifier 140 to recognize delivery information about the package to open the second door 115 of the storage apparatus 100. As described above, the identifier 140 may recognize delivery information about the package by using at least one of a bar code, a QR code, text data, data matrix, a recognition pattern, NFC, RFID, iris recognition, and fingerprint recognition in operation S105. For example, the delivery person may transmit delivery information about the package to the storage apparatus 100 by bringing the pre-registered identification card into contact with the identifier 140.

The second display 122 disposed at the second door 115 may display delivery information about the package recognized by the identifier 140, and the external imaging device 151 may acquire images of the delivery person and the package in operation S110.

When the identifier 140 recognizes the delivery information about the package, the controller 105 may send out a control signal to open the second door 115. The second door 115 may be closed after the delivery person places the package in the storage apparatus 100 through the open second door 115 in operation S115.

After the package is accommodated in the storage apparatus 100, the weight sensor 160 may sense a weight of the package in operation S120 and transmit a sensing signal corresponding to the weight of the package to the controller 105.

When the weight sensor 160 senses the weight of the package and transmits the sensing signal to the controller 105, the controller 105 may determine that the package is introduced into the storage apparatus 100, and the internal imaging device 152 may simultaneously acquire an image of the package inside the storage apparatus 100 in accordance with a control signal to control the internal imaging device 152 of the controller 105 in operation S125.

The temperature sensor 170 may sense an internal temperature of the storage apparatus 100 in which the package is accommodated in operation S130 and transmit an electric signal corresponding to the sensed temperature to the controller 105, and the controller 105 may determine a current internal temperature of the storage apparatus 100 and a change in the temperature based on the received signal.

The communicator 180 may transmit the image of the package acquired by the internal imaging device 152 and the delivery information about the package recognized by the identifier 140 to the external device in operation S135.

The user may confirm the image of the package accommodated in the storage apparatus 100 via the external device and set a storage temperature and a storage time for cold or warm storage based on delivery information about the package in operation S140.

The controller 105 may perform cold storage control or warm storage control for the package in accordance with the package storage temperature and storage time set by the external device in operation S145.

The controller 105 may transmit a notification signal after the cold storage time or warm storage time elapsed in operation S150. After the user opens the first door 110 and picks up the accommodated package, the first door 110 may be closed in operations 5155.

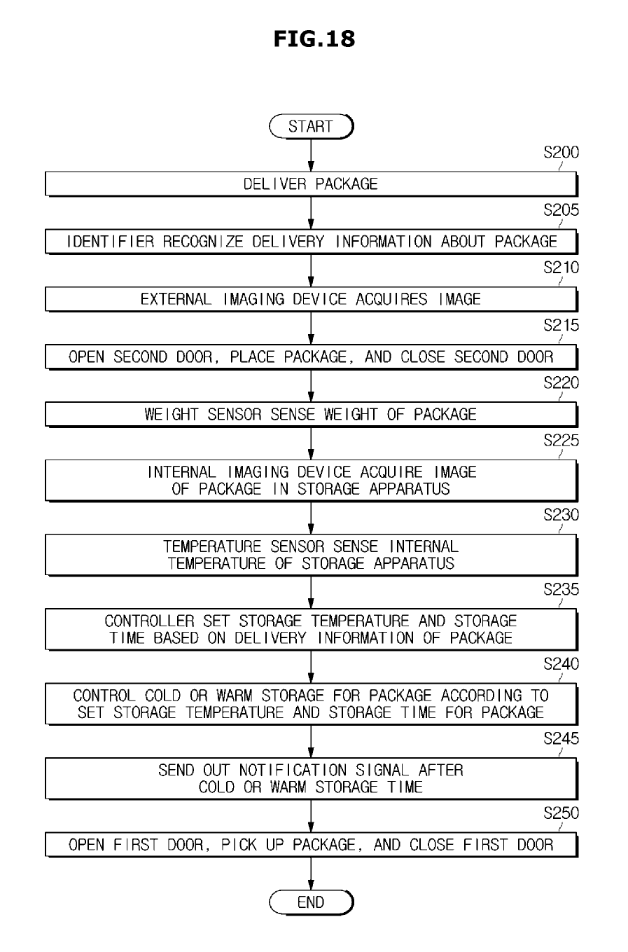

Operations 200 to 230 illustrated in FIG. 18 are the same as operations 100 to 130 illustrated in FIG. 17, descriptions thereof will not be repeated.

Referring to FIG. 18, although the user does not set the storage temperature and the storage time for the package via the external device, the controller 105 may set the storage temperature and the storage time for the package based on delivery information about the package recognized by the identifier 140 in operation S235 and perform cold storage control or warm storage control for the package accommodated in the storage apparatus 100 based on the set storage temperature and storage time for the package in operation S240.

The controller 105 may transmit a notification signal after the cold storage time or warm storage time elapsed in operation S245. After the user opens the first door 110 and picks up the accommodated package, the first door 110 may be closed in operation S250.

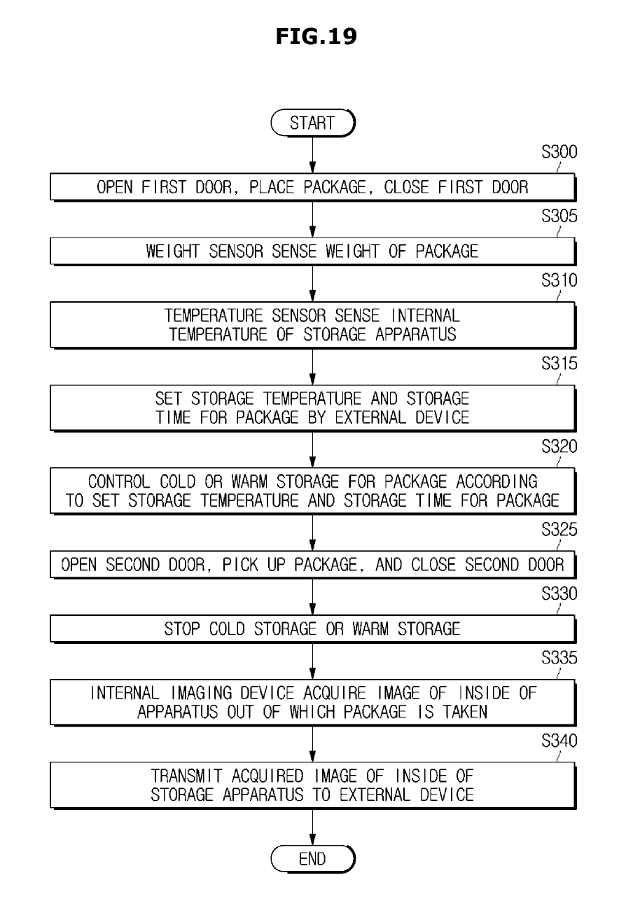

Referring to FIG. 19, the user may open the first door 110, place the package in the storage apparatus 100, and close the first door 110 to return the package in operation S300.

When the package is accommodated in the storage apparatus 100, the weight sensor 160 disposed in the storage apparatus 100 senses a weight of the package in operation S305 and transmits a sensing signal to the controller 105.

Also, the internal imaging device 152 may acquire an image of the package accommodated in the storage apparatus 100, and the temperature sensor 170 may sense an internal temperature of the storage apparatus 100 in which the package is accommodated in operation S310 and transmit an electric signal corresponding to the sensed temperature to the controller 105.

The user may keep the package fresh while the package is accommodated in the storage apparatus 100 by setting the storage temperature and storage time for the package via the external device in operation S315.

When the user sets the storage temperature and storage time for the package, the set information may be transmitted to the controller 105 of the storage apparatus 100 via the communicator 180, and the controller 105 may control the storage apparatus 100 to store the package under cold or warm storage conditions based on the time and temperature set by the user in operation S320.

The delivery person may open the second door 115 to pick up the package accommodated in the storage apparatus 100 by allowing the identifier 140 to recognize delivery information, and the second door 115 may be closed after the delivery person picks up the package accommodated in the storage apparatus 100 in operation S325.

After the package is picked up, the controller 105 may determine that the package is taken out of the storage apparatus 100 and transmit a control signal to stop the cold or warm storage control of the storage apparatus 100 in operation S330.

The internal imaging device 152 may acquire a photograph or video of the inside of the storage apparatus 100 from which the package is removed in operation S335, and the acquired photograph or video may be transmitted to the external device in operation S340. Thus, the user may confirm that the package was normally returned via the screen of the external device.

As is apparent from the above description, the package required to be stored at a controlled temperature, such as food, may be received or returned using the storage apparatus installed to penetrate an external wall of an indoor space and including doors provided in a non-face to face manner such that the delivery person does not meet the consumer for security reasons.

In addition, when the delivered package cannot be immediately picked up while the consumer is out, the consumer may control cold storage or warm storage of the package by setting the storage temperature or the storage time via the external device to keep the package fresh.

Furthermore, as the user may control the cold storage or warm storage at the set temperature only while the package is accommodated in the storage apparatus by setting the temperature and time for the cold or warm storage of the storage apparatus, thereby reducing power consumption.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A storage apparatus configured to store a package, the storage apparatus comprising:
a first door;
a second door provided to face the first door;
an imaging device configured to acquire an image of the package accommodated in the storage apparatus;
a communicator configured to transmit the acquired image of the package to an external device; and
a controller configured to control a storage temperature for the package in accordance with a package storage temperature set by the external device based on the image of the package.

2. The storage apparatus according to claim 1, further comprising a weight sensor configured to sense a weight of the package accommodated in the storage apparatus.

3. The storage apparatus according to claim 2, wherein the controller is further configured to determine that the package is introduced into the storage apparatus when the weight of the package is sensed by the weight sensor and that the package is taken out of the storage apparatus when the weight of the package is not sensed by the weight sensor.

4. The storage apparatus according to claim 2, wherein the imaging device is further configured to acquire an image of the inside of the storage apparatus based on whether or not the weight of the package is sensed by the weight sensor.

5. The storage apparatus according to claim 1, wherein the imaging device comprises:
an internal imaging device configured to acquire an image of the inside of the storage apparatus; and
an external imaging device configured to acquire an image of the outside of the storage apparatus.

6. The storage apparatus according to claim 1, wherein:
the first door is not opened when the second door is opened, and
the second door is not opened when the first door is opened.

7. The storage apparatus according to claim 1, further comprising a temperature sensor configured to sense an internal temperature of the storage apparatus.

8. The storage apparatus according to claim 1, further comprising an identifier configured to recognize delivery information about the package accommodated in the storage apparatus.

9. The storage apparatus according to claim 8, wherein:
the identifier is disposed at the second door, and
the second door is opened when the identifier recognizes the delivery information about the package.

10. The storage apparatus according to claim 8, wherein the identifier is further configured to recognize the delivery information about the package using at least one of a bar code, a QR code, text data, data matrix, a recognition pattern, NFC, RFID, iris recognition, and fingerprint recognition.

11. The storage apparatus according to claim 8, wherein the delivery information about the package comprises at least one of: a type of the package, an storage temperature for the package, a package arrival time, or information about a delivery person of the package.

12. The storage apparatus according to claim 8, wherein the communicator is further configured to transmit the delivery information about the package recognized by the identifier to the external device.

13. The storage apparatus according to claim 7, wherein the controller is further configured to perform a cold storage control or a warm storage control for the package to adjust the internal temperature of the storage apparatus sensed by the temperature sensor to reach a cold storage temperature or a warm storage temperature set by the external device.

14. The storage apparatus according to claim 1, wherein the controller is further configured to perform a cold storage control or a warm storage control for the package based on a cold storage time or a warm storage time for the package set by the external device.

15. The storage apparatus according to claim 1, wherein the controller is further configured to send out a notification signal after a cold storage time or a warm storage time set by the external device elapsed.

16. The storage apparatus according to claim 2, wherein the controller is further configured to stop a cold storage control or a warm storage control when the weight of the package is not sensed by the weight sensor.

17. The storage apparatus according to claim 1, wherein the first door comprises a first display,
wherein the first display is configured to display at least one of: delivery information about the package, cold storage information about the package, or warm storage information about the package.

18. The storage apparatus according to claim 1, wherein the second door comprises a second display,
wherein the second display is further configured to display delivery information about the package.

19. A storage apparatus configured to store a package, the storage apparatus comprising:
a first door;
a second door provided to face the first door;
an identifier configured to recognize delivery information about the package accommodated in the storage apparatus;
a communicator configured to transmit the recognized delivery information about the package to an external device; and
a controller configured to control at least one of a storage temperature and a storage time for the package in accordance with at least one of a package storage temperature and a package storage time set by the external device based on the transmitted delivery information about the package.

20. A storage apparatus configured to store a package, the storage apparatus comprising:
a first door;
a second door provided to face the first door;
an identifier configured to recognize delivery information about the package accommodated in the storage apparatus; and
a controller configured to set at least one of a package storage temperature and a package storage time based on the recognized delivery information about the package and control at least one of a storage temperature and a storage time for the package based on the settings.
